(19) United States
(12) Patent Application Publication
(10) Pub. No.: US 2009/0272453 A1
(43) Pub. Date: Nov. 5, 2009

(54) Transport Pipe for Thick Materials

(76) Inventor: Karl Schlecht, Filderstadt (DE)

Correspondence Address: COLLARD & ROE, P.C., 1077 NORTHERN BOULEVARD, ROSLYN, NY, 11576, US

(21) Appl. No.: 12/225,777

(22) PCT Filed: Mar. 15, 2007
(86) PCT No.: PCT/EP2007/002278

§ 371 Date: Sep. 29, 2008

(30) Foreign Application Priority Data
Apr. 4, 2006 (DE) 10 2006 016 084.3

(51) Int. Cl. F16L 23/024; B65G 53/32

(52) U.S. Cl. 138/109; 29/458; 138/177

(57) ABSTRACT

The invention relates to a transport tube for thick materials, in particular for concrete. The transport tube comprises substantially a pressure tube (16) from wear-resistant tube material, which is preferably hardened on the inside, and at least one coupling ring (18′, 18″) which is fixed with a material-to-material fit at the end to the outer face of the pressure tube (16). According to the invention, the coupling ring (18′, 18″) has a first ring part (34) having an inner face of excess dimensions with respect to the outer face of the pressure tube (16), and a second ring part (36) which adjoins the first ring part (34) axially and has an inner cone which deviates in its axial profile from the outer face of the pressure tube (16) as far as an undersize. The coupling ring (18′, 18″) is pressed onto the outer face of the pressure tube (16) with the inner cone (38) of its second ring part (36). Furthermore, it delimits an annular gap space (40) with its first ring part (34) together with the pressure tube (16), which annular gap space (40) is filled at least partially with an adhesive to produce the material-to-material connection.

The invention relates to a transport pipe for thick substances, particularly for concrete, having a pressure pipe made of wear-resistant material, and having at least one coupling ring fixed in place on the outer surface of the pressure pipe, on the end side, with material fit.

In the construction industry, mobile concrete pumps are used in many cases, with which concrete is conveyed from a feed location to an application location on the construction site, by way of transport pipes. The transport pipes are usually situated on the mast arms of a distributor mast, which can be directed to the concrete application location with an end hose, by way of a remote control. Furthermore, cases of use are known, in which stationary concrete pumps are used, where the transport pipes are laid from the feed location to the application location, fixed to the ground. The coupling rings disposed at the ends of the transport pipes ensure that multiple transport pipes can be connected with one another, for example by way of shell couplings. The coupling rings can be welded onto the pressure pipe. A disadvantage in the case of a welded coupling ring is that a reduction in hardness of the pressure pipe occurs as a result of the temperature effect during the welding process. Furthermore, it is known to glue the coupling ring onto the pressure pipe. However, problems in centering and fixation of the coupling ring on the pressure pipe and in sealing of the coupling ring relative to the pressure pipe occur during the production process, as long as the adhesive has not yet solidified sufficiently, and these problems have not yet been solved satisfactorily.

Accordingly, the invention is based on the task of improving the known transport pipe of the type indicated initially, to the effect that during fixation of the coupling ring on the pressure pipe, centering and sealing on at least one side takes place in this region, at the same time.

To accomplish this task, the combinations of characteristics indicated in claims 1 and 15 are proposed. Advantageous embodiments and further developments of the invention are evident from the dependent claims.

The solution according to the invention essentially consists in the fact that the coupling ring has a first ring part having an inner surface that demonstrates an excess dimension relative to the outer surface of the pressure pipe, and a second ring part, axially following the first ring part, having a conical inner surface that diverges in its axial progression, down to a reduced dimension relative to the outer surface of the pressure pipe, that the coupling ring is pressed onto the outer surface of the pressure pipe with the conical inner surface of its second ring part, with friction fit, and delimits a ring-shaped gap space with its first ring part, together with the pressure pipe, and that the gap space is filled at least partially with an adhesive that forms the material-fit fixation. In this connection, the inner cone in the region of the second ring part ensures centering and fixation of the coupling ring on the pressure pipe as well as sealing towards the related face side of the transport pipe, at least until the adhesive hardens.

In order to guarantee uniform circumference distribution of the adhesive within the gap space, it is proposed, according to a preferred embodiment of the invention, that the coupling ring has ring grooves that are open towards the inside and filled with adhesive, in the region of the inner surface of its first ring part. Furthermore, the coupling ring has at least one filling bore disposed in the region of the first ring part, passed radially through the ring mantle, through which bore liquid adhesive is applied to the gap space during the production process. It is advantageous if two filling bores that are disposed offset from one another in the circumference direction, preferably lying diametrically opposite one another, are provided. It is practical if the filling bores open into one of the ring grooves in the first ring part. In this connection, the ring groove directly adjacent to the second ring part is preferably chosen.

On the other hand, according to a first embodiment variant, the ring space is open towards the free end of the first ring part of the coupling ring. This opening forms a ventilation opening, at the same time, during the filling process. Furthermore, the filling process can be monitored by watching that adhesive exits uniformly from this ring-shaped opening.

In deviation from this, according to a second embodiment variant, the gap space can be closed towards the free end of the first ring part of the coupling ring. This is achieved, for example, in that a ring-shaped lip that lies against the outer surface of the pressure pipe, forming a seal, is disposed on the free end of the first ring part; it is practical if this lip engages into the interior of the gap space with its inner edge, at a slant. In this case, it is practical if the lip delimits a ring groove that communicates with a ventilation bore. In this case, too, the filling process can be monitored by watching that adhesive exits uniformly from the ventilation bore.

It is advantageous if the coupling ring is provided, on the outside, with a ring-shaped circumferential coupling groove for the engagement of a shell coupling. In this connection, the circumferential coupling groove can be disposed in the region of the first ring part, whereby the gap space passes through at least partially under the coupling groove. Fundamentally, however, it is also possible to dispose the circumferential coupling groove in the region of the second ring part, whereby the inner cone passes through at least partially under the coupling groove. At the inlet-side end of a feed line, in particular, it is advantageous if a friction-wear ring, for example made of carbide material, is inserted into the coupling ring, following the pressure pipe on the face side. There, the friction-wear ring can rest against an inside shoulder of the coupling ring, on the face side. In this connection, it is particularly advantageous if the friction-wear ring is inserted into a third ring part, having a cylindrical inner surface, which follows the conical second ring part of the coupling ring, whereby the third ring part can have a smaller inside diameter than the first cylindrical ring part.

The invention furthermore relates to a new method for the production of a transport pipe for thick substances, in which a pressure pipe made of wear-resistant material is connected with a coupling ring, on the end side, with material fit. To accomplish the task stated initially, it is proposed, in this connection, that the coupling ring is pushed onto an end of the pressure pipe, on the outside, and pressed onto the pressure pipe with an inner cone that partially has a reduced dimension relative to the pressure pipe, and centered there, and that when the coupling ring is pushed on, a ring-shaped gap space that forms between a first ring part and the pressure pipe has liquid adhesive under pressure applied to it, which adhesive subsequently hardens or is reacted, causing it to solidify. In this connection, the adhesive can be injected into the ring space through at least one wall bore of the coupling ring. It is advantageous if the liquid adhesive is distributed uniformly over the circumference of the ring space, to a great extent, when it is injected in by way of inner ring grooves. Adhesive is applied to the gap space until it exits from the gap space at a ring-shaped opening in the region of the free end of the coupling ring. Pressing the coupling ring onto the pressure pipe by way of its inner cone assures sufficient centering and fixation between coupling ring and pressure pipe, at least until the adhesive has hardened. As a result, handling of the transport pipes during production is simplified.

In the following, the invention will be explained in greater detail using exemplary embodiments shown schematically in the drawing. This shows:

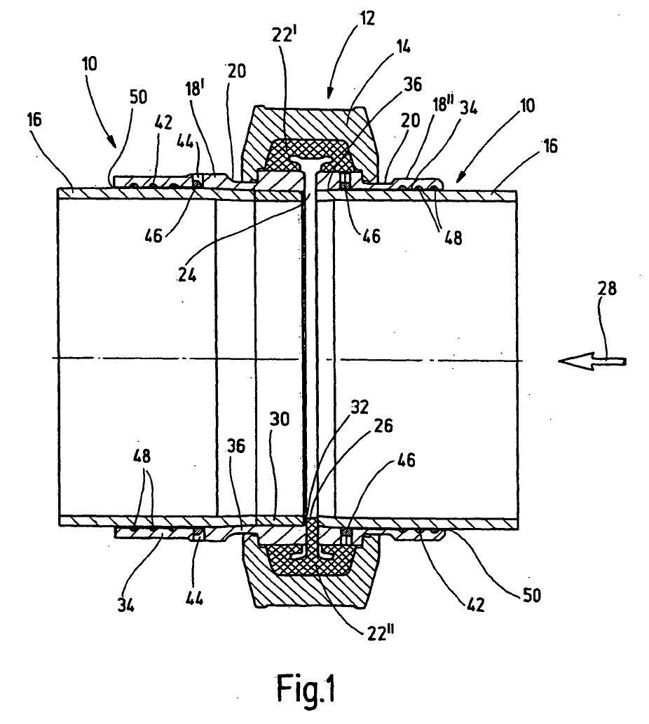

FIG. 1 a longitudinal section through the ends of two transport pipes for abrasive thick substances, which ends are coupled with one another;

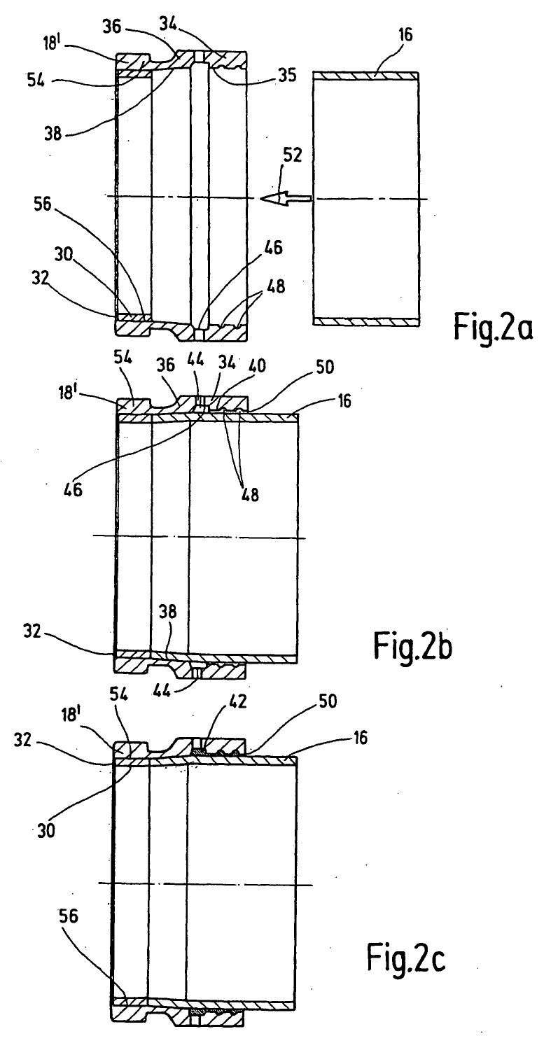

FIG. 2a to c three sectional representations to illustrate the production method according to the invention;

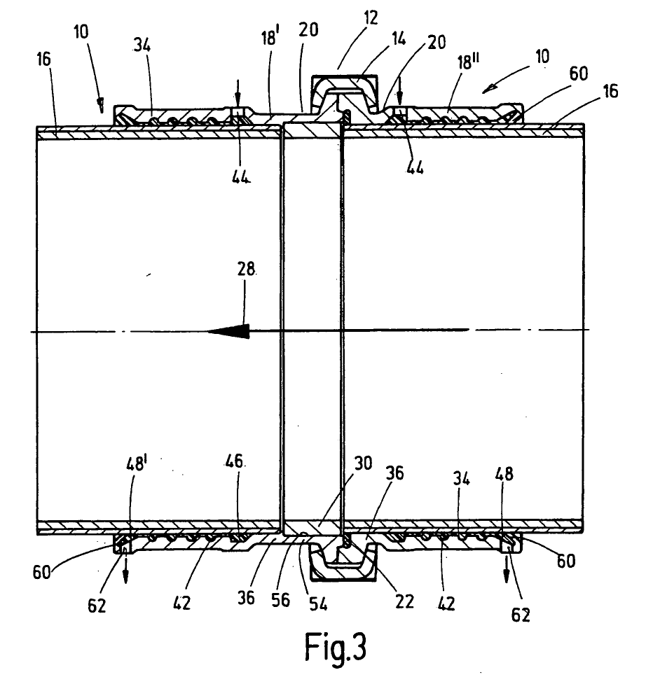

FIG. 3 a longitudinal section through the ends of two transport pipes, coupled with one another, with coupling rings that are modified as compared with FIG. 1.

The transport pipes 10, a detail of which is shown in FIG. 1 and 3, in the region of a coupling location, are intended for the transport of thick substances, particularly liquid concrete for use in concrete pumps. The transport pipes 10 can be connected with one another in pairs, at coupling locations 12, for example using a shell coupling 14. For this purpose, the transport pipes 10 have a pressure pipe 16, for example made of hardened steel, which carry a coupling ring 18′ or 18″ at their ends. The coupling rings 18′, 18″ have a circumferential coupling groove 20 for engagement of the shell coupling 14, in each instance. The shell coupling 14 in turn carries an inner seal 22, 22′, 22″, which either leaves the gap region 24 between the two transport pipes open (FIG. 1: seal 22′ top) or closes it off with a circumferential bead 26 (FIG. 1: seal 22″ bottom), or is disposed between the face surfaces of the coupling rings 18′, 18″ (FIG. 3: seal 22).

In FIG. 1 and 3, the transport direction is indicated with an arrow 28. Furthermore, it is evident from FIG. 1 and 3 that the inlet-side end of the transport pipes 10 additionally contains a friction-wear ring 30 made of carbide material, which is laid into the related coupling ring 18′ and follows the adjacent pressure pipe 16 on the face side there, and rests against a face-side inside shoulder 32 of the coupling ring 18′ with its other end. In this connection, the friction-wear ring 30 is laid into a third ring part 54 having a cylindrical inner surface 56, which follows the second ring part 36 of the coupling ring 18′, and has a smaller inside diameter than the first ring part 34.

On the outlet-side end of the other transport pipe 10, the friction-wear ring 30 is absent. The-outlet-side coupling ring 18″ can therefore be configured to be somewhat shorter than the inlet-side coupling ring 18′.

The two coupling rings 18′, 18″ have a first ring part 34 having a cylindrical inner surface 35 that has an excess dimension relative to the outer surface of the pressure pipe 16, as well as a second ring part 36 that follows the first ring part 34, having an inner cone 38 that diverges in its axial progression, down to a reduced dimension relative to the outer surface of the pressure pipe. The coupling rings 18′, 18″ are pressed onto the outer surface of the pressure pipe 16 with the inner cone 38 of their second ring part 36. Each coupling ring 18′, 18″ delimits a ring-shaped gap space 40 with its first ring part, together with the pressure pipe 16, which space is filled with an adhesive 42 that produces a material-fit connection. Two filling bores 44 that lie diametrically opposite one another are provided in the coupling rings 18′, 18″, in each instance, which bores open into a circumferential inner groove of the coupling rings 18′, 18″. The inner groove 46 as well as additional inner grooves 48 communicate with the narrower parts of the gap space 40 and ensure that the adhesive 42 is distributed uniformly over the circumference.

In the case of FIG. 1, the gap space 40 reaches all the way to the ring-shaped opening 50 at the rear end of the coupling rings 18′, 18″, by way of which it is ventilated during the filling process. When the gap space 40 is filled, adhesive exits from the opening 50.

In the case of the exemplary embodiment shown in FIG. 3, the gap space 40 is closed off at the rear end of the coupling rings 18′, 18″. This is achieved in that the first ring part 34 rests against the outer surface of the pressure pipe 16, at its free end, with a lip 60 that points inward. The lip 60 engages into the interior of the gap space with its inner edge, at a slant, and there delimits a ring-shaped inner groove 48′ that communicates with the gap space and opens into a ventilation bore 62. During the filling process, the gap space is ventilated by way of the ventilation bore 62. When the gap space 40 is filled, adhesive exits from the ventilation bore 62.

In the region of the inlet-side end of the coupling ring 18′, the gap space 40 filled with adhesive 42 is situated completely outside of the coupling groove 20, while in the case of the outlet-side end of the coupling ring 18″, the gap space 40 passes through under the coupling groove 20. The deciding factor for the strength of the material-fit connection is the length of the adhesive layer 42 that extends over the gap space 40, which is approximately the same in both-cases.

The different steps in the production of the transport pipes 10 can be seen in the sequence of FIGS. 2a to 2c. First, the pre-finished coupling ring 18′, if applicable with the inserted friction-wear ring 30, and the pressure pipe 16 are inserted into one another in the direction of the arrow 52 (FIG. 2a) and subsequently pressed together with a press, in the region of the inner cone 38 (FIG. 2b). In this connection, both the coupling ring 18′ and the pressure pipe 16 are centered and connected with one another with friction fit, whereby the ring-shaped gap space 40 remains free. Then liquid adhesive 42 is injected into the gap space 40, under pressure, by way of the filling bores 44, so that it is uniformly distributed over the gap space circumference, by way of the inner grooves 46, 48, and fills it all the way to the opening 50. As long as the adhesive has not hardened yet, the friction-fit connection in the region of the inner cone 38 assures centering, fixation, and sealing of the connection partners, so that simple handling of the transport pipe 10 is possible in this state. After the adhesive has hardened, it ensures a permanent, material-fit connection (FIG. 2c).

In summary, the following should be stated: The invention relates to a transport pipe for thick substances, particularly for concrete. The transport pipe essentially consists of a pressure pipe 16 made of wear-resistant pipe material, preferably hardened on the inside, and at least one coupling ring 18′, 18″ fixed in place on the outer surface of the pressure pipe 16, on the end side, with material fit. According to the invention, the coupling ring 18′, 18″ has a first ring part 34 having an inner surface that demonstrates an excess dimension relative to the outer surface of the pressure pipe 16, as well as a second ring part 36, axially following the first ring part 34, having an inner cone that diverges in its axial progression, down to a reduced dimension relative to the outer surface of the pressure pipe 16. The coupling ring 18′, 18″ is pressed onto the outer surface of the pressure pipe 16 with the inner cone 38 of its second ring part 36. Furthermore, it delimits a ring-shaped gap space 40 with its first ring part 34, together with the pressure pipe 16, which space is filled at least partially with an adhesive for producing the material-fit connection.

1: Transport pipe for thick substances, particularly for concrete, having a pressure pipe (16) made of wear-resistant material, and having at least one coupling ring (18′, 18″) fixed in place on the outer surface of the pressure pipe (16), on the end side, with material fit, wherein the coupling ring (18′, 18″) has a first ring part (34) having an inner surface that demonstrates an excess dimension relative to the outer surface of the pressure pipe (16), and a second ring part, axially following the first ring part (34), having an inner cone (38) that diverges in its axial progression, down to a reduced dimension relative to the outer surface of the pressure pipe (16), that the coupling ring (18′, 18″) is pressed onto the outer surface of the pressure pipe (16) with the inner cone (38) of its second ring part (36), and delimits a ring-shaped gap space (40) with its first ring part (34), together with the pressure pipe (16), and that the gap space (40) is filled at least partially with adhesive (42), forming the material-fit connection.

2: Transport pipe according to claim 1, wherein the coupling ring (18′, 18″) has ring grooves (46, 48) that are open towards the inside and filled with adhesive, in the region of the inner surfaces of its first ring part (34).

3: Transport pipe according to claim 1, wherein the coupling ring (18′, 18″) has at least one filling bore (44) disposed in the region of the first ring part (34), passed radially through the ring mantle.

4: Transport pipe according to claim 3, wherein at least two filling bores (44) that are disposed offset from one another in the circumference direction are provided.

5: Transport pipe according to claim 4, wherein the at least one filling bore (44) opens into one of the ring grooves (46) in the first ring part (34).

6: Transport pipe according to claim 5, wherein the at least one filling bore (44) opens into the ring groove (46) directly adjacent to the second ring part (36).

7: Transport pipe according to claim 1, wherein the gap space (40) is open towards the free end of the coupling ring (18′, 18″).

8: Transport pipe according to claim 1, wherein the gap space (40) is closed towards the free end of the coupling ring (18′, 18″).

9: Transport pipe according to claim 8, wherein a ring-shaped lip (60) that lies against the outer surface of the pressure pipe (16), forming a seal, is disposed on the free end of the coupling ring (18′, 18″).

10: Transport pipe according to claim 9, wherein the lip (60) is directed in the direction of the gap space (40) with its inner edge, at a slant.

11: Transport pipe according to claim 9, wherein the lip (60) delimits a ring groove (48′) into which a ventilation bore (62) opens.

12: Transport pipe according to claim 1, wherein the coupling ring (18′, 18″), on the outside, has a ring-shaped circumferential coupling groove (20) for the engagement of a shell coupling.

13: Transport pipe according to claim 12, wherein the circumferential coupling groove (20) is disposed in the region of the first ring part (34), whereby the gap space (40) passes through at least partially under the coupling groove (20).

14: Transport pipe according to claim 12, wherein the circumferential coupling groove (20) is disposed in the region of the second ring part (36), whereby the inner cone (38) passes through at least partially under the coupling groove (20).

15: Transport pipe according to claim 1, wherein a friction-wear ring (30) is inserted into the coupling ring (18′), following the pressure pipe (16) on the face side.

16: Transport pipe according to claim 15, wherein the friction-wear ring (30) rests against an inside shoulder (32) of the coupling ring (18′), on the face side.

17: Transport pipe according to claim 15, wherein the friction-wear ring (30) is inserted into a third ring part (54), having a cylindrical inner surface, which follows the second ring part (36) of the coupling ring (18′).

18: Transport pipe according to claim 17, wherein the third ring part (54) has a smaller inside diameter than the first ring part (34).

19: Method for the production of a transport pipe for thick substances, in which a pressure pipe (16) made of wear-resistant material is connected with a coupling ring (18′, 18″), on the end side, with material fit, wherein the coupling ring (18′, 18″) is pushed onto an end of the pressure pipe (16), on the outside, and pressed onto the pressure pipe with an inner cone (38) that partially has a reduced dimension relative to the pressure pipe (16), and centered there, and that when the coupling ring (18′ 18″) is pushed on, a ring-shaped gap space (40) that forms between a first ring part (34) and the pressure pipe (16) has a liquid adhesive under pressure applied to it, which adhesive subsequently hardens or is reacted, causing it to solidify.

20: Method according to claim 19, wherein the adhesive (42) is injected into the gap space (40) through at least one filling bore (44) of the coupling ring (18′ 18″) until it exits from a free opening (50, 62) of the gap (40).

21: Method according to claim 19, wherein the liquid adhesive is distributed over the circumference of the gap space (40) when it is injected in by way of inner ring grooves (46, 48).
